(19) United States
(12) Patent Application Publication
(10) Pub. No.: US 2005/0281053 A1
(43) Pub. Date: Dec. 22, 2005

(54) Light generating device comprising light input and light output units

(75) Inventor: Johannes Marra, Eindhoven (NL)

Correspondence Address: PHILIPS ELECTRONICS NORTH AMERICA CORPORATION;INTELLECTUAL PROPERTY & STANDARDS, 1109 MCKAY DRIVE, M/S-41SJ, SAN JOSE, CA, 95131, US

(73) Assignee: KONINKLIJKE PHILIPS ELECTRONICS N.V., EINDHOVEN (NL)

(21) Appl. No.: 10/527,947

(22) PCT Filed: Aug. 8, 2003
(86) PCT No.: PCT/IB03/03552

§ 371 Date: Mar. 15, 2005

(30) Foreign Application Priority Data
Sep. 18, 2002 (EP) 02078866.7

(51) Int. Cl. F21V 7/04

(52) U.S. Cl. 362/617

(57) ABSTRACT

The present invention relates to a light generating device comprising a slab light guide (1) having two substantially parallel sides (10, 11) and at least one edge (12), the edge (12) having a surface connecting the surfaces of said sides (10, 11). In order to provide a device that can be used in a wide range of applications and wherein the light guide (1) acts as a buffer of light, the light generating device according to the present invention further comprises:
at least one light input unit (2) arranged on at least one side (10) of said light guide (1) comprising at least one light source (20) and a light incoupling means (21) for coupling light into said light guide (1), and
at least one light output unit (3) arranged on at least one side (11) of said light guide (1) comprising a light outcoupling means for coupling light out of said light guide (1). The present invention further relates to a display device comprising a light generating device according to the invention.

The present invention relates to a light generating device comprising a slab light guide having two substantially parallel sides and at least one edge, the edge having a surface connecting the surfaces of said sides. Further, the present invention relates to a display device.

Currently used slab light guides, such as those used for the back-illumination of thin LC display screens, are typically of the edge-lit (also called side-lit) type where a light source, partially surrounded by a reflector, is positioned adjacent to at least one of the edges of the light guide such that its light is directed into the light guide via its edges. Such a slab light guide is, for instance, disclosed in WO 01/63588 A1. Light captured in the light guide propagates through the light guide via total internal reflections (TIR) and is normally coupled out of the light guide and directed away from the light guide via optical interactions of the propagating light inside the light guide with light scattering and/or reflecting/refracting means such as scattering dots, scattering surface patterns, or other optical “irregularities” provided to the light guide surfaces, or via specially produced topographies in/on the light guide surfaces, all light scattering and/or reflecting/refracting means having in common that they “frustrate” the total internal reflections and induce light outcoupling from the light guide. Alternatively, specially textured optical foils may be brought into optical contact with the light guide for the purpose of light outcoupling and its subsequent directing. With such a set-up it is possible that the entire edge-lit backlight can be contained within a space having only a small thickness, which is important for applications involving i.e. thin notebook screens or thin LC monitor screens.

The known slab light guides work well, in principle, for the back-illumination of small-sized flat display screens, however, problems arise when they are to be used for the back-illumination of large-area flat display screens or as large-area luminaire tiles for general lighting purposes. In as far as general lighting is concerned, a known solution is to replace the ordinarily used fixed light sources together with their fixtures by a large-area edge-lit slab light guide provided with a plurality of localized light redirecting means, such as scattering dots or reflecting/refracting surface topographies on the light guide surface, the spacing between adjacent light redirecting means being made dependent on their distance from the light source. However, using practically feasible light guide thicknesses up to 10 mm, it has proven difficult so far to efficiently couple light from light sources into a light guide via its edge and to maintain a satisfactory degree of brightness uniformity of the outcoupled light across the entire large-area light guide outcoupling surface at arbitrary brightness levels. The lumen incoupling efficiency is invariably poor, which is primarily due to the relatively small thickness of the light guide edge when compared with the diameter of energy-efficient tubular light sources such as T5 or T8 fluorescent lamps. The efficiency with which light from e.g. a non-tubular high-intensity discharge (HID) lamp can be coupled into the edge of a light guide is even worse.

Furthermore, the space near the light guide edges wherein the usually tubular light sources must be positioned is limited and does not scale with the surface area of the light guide. The locally attainable intensity of the outcoupled light at an arbitrary position on the light guide outcoupling surface is therefore normally quite limited. Proper collimation of the outcoupled light from the light guide generally requires the additional use of optical foils that are very expensive.

It is therefore an object of the present invention to provide a light generating device that overcomes the above described problems and that can be used in different applications, wherein the number of light sources used can be scaled with the total area of the light guide, and that allows the creation of a collimated beam of emitted light at a controlled lateral brightness uniformity at high brightness levels.

This object is achieved according to the present invention by a light generating device as claimed in claim 1 comprising
a slab light guide having two substantially parallel sides and at least one edge, the edge having a surface connecting the surfaces of the said sides,
at least one light input unit, arranged on at least one side of said light guide, comprising at least one light source and a light incoupling means for coupling light into said light guide, and
at least one light output unit, arranged on at least one side of said light guide, comprising a light outcoupling means for coupling light out of said light guide.

The present invention is based on the idea to provide at least one light input unit and at least one light output unit which, dependent on the application and contrary to the known devices, can be arranged anywhere at any position on at least one side of said light guide. This enables the light guide to act as a light buffer between the light input and light output units which are not directly optically coupled to each other. Light buffering inside the light guide promotes light intensity homogenisation to be attained across the surface area of the at least one side of the light guide covered by the at least one light output unit, which is advantageous for obtaining outcoupled light of a rather uniform lateral brightness level. The indirect degree of coupling between the light input and light output units via the light guide is proportional to their respective areas of optical contact with the light guide, i.e. to their apertures, and additionally depends on the positioning of the respective light input units and light output units on at least one side of the said light guide with respect to each other.

The number of light sources, e.g. lamps, used in the light input units can be scaled with the side area of the light guide and can thus be made to scale with a display screen surface area that must be illuminated or with the surface area of a light-emitting luminaire tile. This allows light generating devices to be created that, dependent on the details of their design, enable a high degree of lateral brightness uniformity to be attained at high brightness levels pertaining to the emitted light from the at least one light output unit arranged on at least one side of said light guide, or enable light concentration or light dilution to be accomplished. Furthermore, dependent on the design parameters of the at least one light output unit, light can be emitted from the light generating device that possesses a certain degree of collimation This is useful e.g. for illuminating a LCD screen positioned directly adjacent to the at least one light output unit. In addition, apart from its application for display illumination or for luminaire applications in the area of general lighting, the light generating device according to the present invention can be used for spot illumination.

Preferred embodiments of the invention are defined in the dependent claims. A display device comprising a display screen and a light generating device according to the invention is claimed in claims 14 and 15.

The light incoupling means of the light input units preferably comprises a plurality of incoupling optical elements that are in optical contact with the surface of the side of said light guide on which the at least one light input unit is arranged. Such incoupling optical elements can be in the form of ribs or cubes or cylinders possessing a round or oval cross-section, having different sections and surfaces as defined further in claims 2 to 5.

Similarly, the light outcoupling means of the light output units may comprise a plurality of outcoupling optical elements that are in optical contact with the surface of the side of the light guide on which the at least one light output unit is arranged. Also the outcoupling optical elements can be in the form of ribs or cubes or cylinders of round or oval cross-section. Preferred embodiments thereof are defined in claims 6 and 7. Said outcoupling optical elements are preferably arranged at intervals, and between said outcoupling optical elements light reflecting means are arranged, in particular a shaped foil, having a reflective surface facing away from said light guide, in particular a specular reflecting surface that is inclined with respect to the transparent surface section of said outcoupling optical elements, the separation between said transparent surface section of said outcoupling optical elements and said specular reflecting surface of said shaped foil widening in the direction away from the said light guide. Such a shaped foil can be conveniently obtained via the thermal deep-drawing of a sheet of plastic or metal into the desired shape, which sheet is subsequently provided with specular reflection walls, e.g. by the deposition of a silver or aluminium layer onto the plastic or metal walls, and subsequently positioned in between the outcoupling optical elements

According to an advantageous embodiment, the light guide is provided with light reflection means, in particular a specular or diffuse reflector, at its edge, the diffuse reflector being substantially not in optical contact with the light guide. Thus, the light rays will be forced to propagate through the light guide via TIR until they exit the light guide either via the light input unit or via the light output unit. An additional reflecting surface is preferably positioned behind and/or around the at least one light source in the at least one light input unit, that is, in the direction away from the light incoupling means, to redirect light rays propagating away from the light incoupling means back towards the light incoupling means. The presence of the said additional reflecting surface allows light recycling to be accomplished within the light input unit.

Preferably, for use as a homogeneously light-emitting back-lighting unit for a large-area LC display screen the light input unit is spread across the whole surface area of the side of the light guide on which it is arranged. Further, individual light sources can be regularly positioned along this side within the light input unit. Similarly, the light output unit can be spread across the whole surface area of the side of the light guide on which the light output unit is arranged.

For use as a light concentrator another embodiment is advantageously applied according to which the surface area of the at least one side of the light guide covered by the at least one light input unit is larger than the surface area of the at least one side of the light guide covered by the at least one light output unit, i.e. the surface area covered by the light output unit is smaller than the surface area covered by the light input unit. This embodiment can be used for general lighting purposes, e.g. for emitting a collimated beam of light of high intensity or for spot lighting or for concentrating sunlight captured by the light input unit.

In a still further embodiment, the dimensions can be provided vice versa, i.e. the surface area of the at least one side of the light guide covered by the light output section can be made larger than the surface area of the at least one side of the light guide covered by the light input section. Such an embodiment is preferably used as a light diluter and/or as a lateral light intensity homogeniser applied, for instance, in the area of general lighting.

In a still further embodiment, a light-directing means is provided in the at least one light input unit for directing light, in particular sunlight and/or light from external light sources, into the light input unit. Thus, additional light can be coupled into the light guide and the sun can be used as a light source.

For use as decorative lighting, a preferred embodiment of the light generating device comprises at least one light output unit provided with a transparent fixing means for non-permanently fixing the light output unit at an arbitrary position onto a side of the light guide. This allows the light emitted from, for instance, a single TL light source facing the side of the light guide that is provided with the light input unit to be emitted from several distinct light output units arranged on, for instance, the opposite side of the light guide. These several light output units are then visualised as distinct spots, each of them emitting collimated light, with a spot shape corresponding to the shape of the transparent fixing means with which the light output unit is fixed and optically contacted to the light guide. The shape of the TL light source is not visible then to the viewer facing the side of the light guide that is provided with the light output units. In this embodiment of the light generating device, the light emitted from the TL light source is captured by the light incoupling means and coupled into the light guide wherein a light homogenisation occurs through TIR, enabling a redistribution of the captured light over several light output units that may be brought into optical contact with a side of the light guide across a contacting surface area, i.e. the contacting area of the transparent fixing means, possessing an arbitrary 2-dimensional shape. A suitable fixing means is found to be a layer of transparent silicone rubber that, when pressed against the smooth surface of a light guide side, allows both adhesion and optical contact to be established between the silicone rubber layer and the light guide, thereby establishing optical contact between the light guide and the light outcoupling means of the light output unit. Thus, at least one light output unit can be mounted on a side of the light guide at variable positions which can be changed by the user.

The invention will now be explained in more detail with reference to the drawings in which

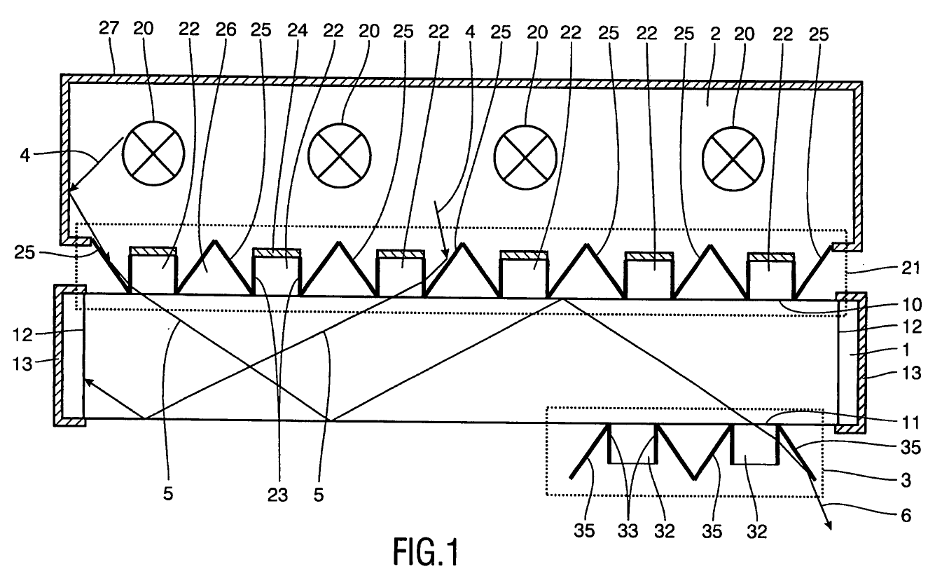

FIG. 1 shows a first embodiment of a light generating device suitable for use as a light concentrator,

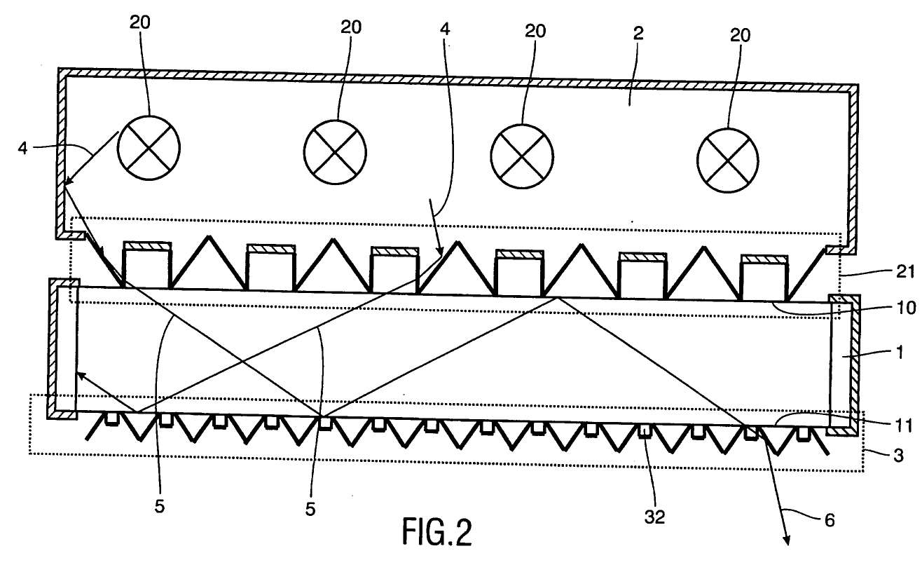

FIG. 2 shows a second embodiment of a light generating device suitable for use as a back-lighting unit,

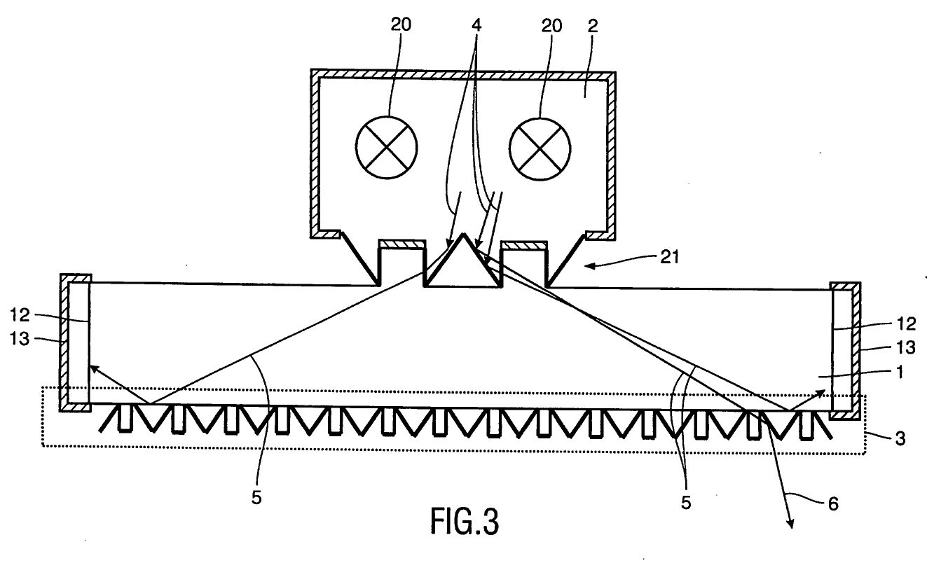

FIG. 3 shows a third embodiment of the light generating device suitable for use as a light diluter/homogeniser,

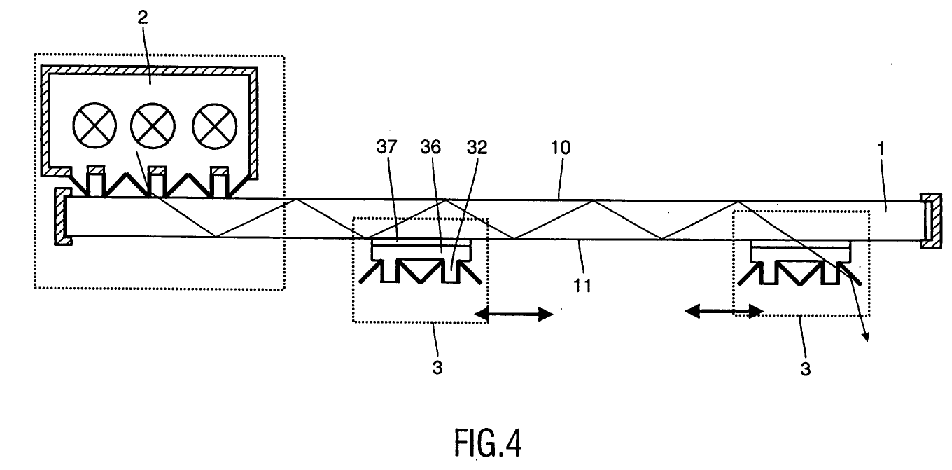

FIG. 4 shows a fourth embodiment of the light generating device suitable for the creation of spot illumination, and

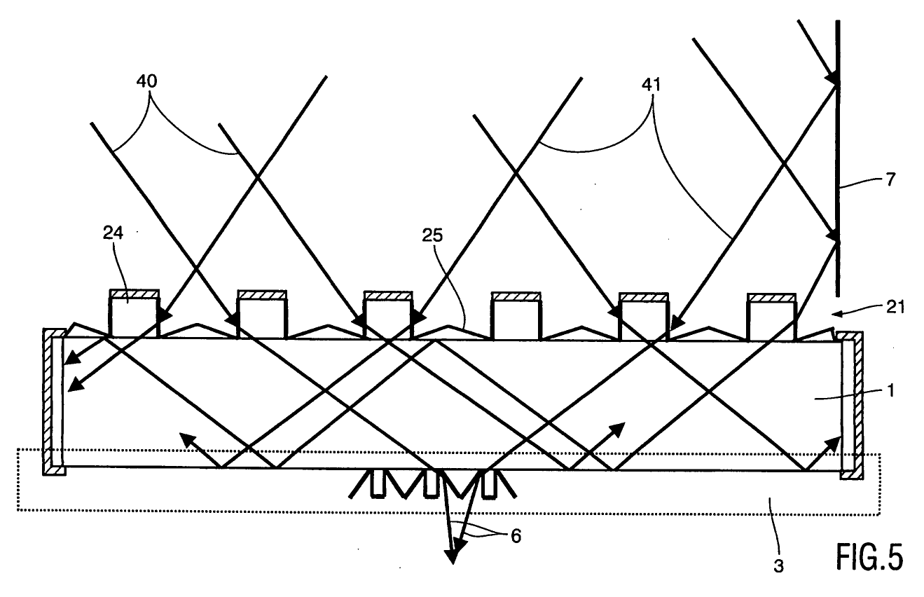

FIG. 5 shows a fifth embodiment of the light generating device using sunlight.

FIG. 1 shows a first embodiment of a light generating device according to the present invention. Said device comprises a slab light guide 1, a light input unit 2 arranged on one side of the light guide 1 and a light output unit 3 arranged on another side of the light guide 1. The light guide 1 has two substantially parallel sides 10, 11 and an edge 12 which has a surface connecting the surfaces of the sides 10, 11. The light input section 2 covers the entire side 10 of the light guide 1; the light output section 3 covers only part of the side 11 of the light guide 1.

Within the light input unit 2 four lamps 20 are provided at equal intervals for generating light. For incoupling the generated light into the light guide 1, the light input unit 2 further comprises light incoupling means 21 comprising a plurality of incoupling optical elements 22 in the form of ribs or cubes or upstanding cylinders of round or oval cross section in optical contact with the flat light guide surface 10. The upstanding surfaces 23 of the optical elements 22 that are aligned substantially perpendicularly to the light guide surface 10, are optically smooth and serve to couple light from the light input unit 2 into the interior of the light guide 1. The surfaces 24 of the optical elements 22 that are aligned parallel to the light guide surface 10 are covered with a reflecting layer, preferably having a reflectivity of substantially 100%, to prevent any light entering the light guide 1 that cannot propagate through the light guide 1 by TIR. Preferably, the surfaces 24 of the optical elements 22 are diffuse-reflective at the side of said surfaces 24 facing away from the light guide.

The light guide surface between adjacent optical elements 22 is shielded from direct exposure to the light generated by the light sources 20 by a shaped foil or mask 25 having a diffusely or specularly reflecting layer on the side facing the light sources 20. This shielding foil 25 is preferably not in optical contact with the light guide 1 so that cavities 26 are formed between the foil 25 and the light guide surface 10.

The light input unit 2 including the light sources 20 is at least partly surrounded by a diffuse reflector 27, except of course when the sun or an external light source shall be used as the light source for generating light 4 to be coupled into the light guide 1. Said diffuse reflector 27 preferably has a reflectivity of 100% to maximize the lumen output and light recycling efficiency within the light input unit 2.

Captured light rays 5 propagate through the light guide 1 via TIR. They may exit either via the upstanding walls 23 of the incoupling optical elements 22 of the light incoupling means 21, which brings them back in the cavity of the light input unit 2 containing the light sources 20 from where they can be recycled and again coupled into the light guide 1, or they may exit via the upstanding optically transparent surfaces 33 of outcoupling optical elements 32 of the light output unit 3.

The outcoupling optical elements 32 may also be formed as ribs or cubes or upstanding cylinders of round or oval cross-section, as shown, and are surrounded by a structured foil 35 possessing a specular-reflecting inclined surface with respect to the transparent surface 33 of outcoupling optical element 32 that enables the exiting light 6 to acquire a degree of collimation via at least one specular reflection from the inclined surfaces of the structured foil 35. The separation distance between the specular reflecting surface of the said shaped foil 35 and the transparent surface 33 of outcoupling element 32 preferably widens in the direction away from the light guide surface 11.

The light generating device according to the present invention comprising a slab light guide, a light input unit and a light output unit, enables the light guide 1 to act as a light buffer between the input and output units 2, 3. These units 2, 3 are not directly optically coupled to each other, the (indirect) degree of optical coupling between them has a proportionality with their apertures, i.e. their respective areas of optical contact with the light guide 1. The extent of light buffering between the light input unit 2 and light output unit 3 possesses therefore an inverse proportionality to the aperture of both the input and output units 2, 3. The (indirect) degree of optical coupling between the units 2,3 additionally depends on the positioning of the respective units 2,3 with respect to each other on the sides of the light guide 1.

At the edges 12 of the light guide 1, TIR light propagating in one direction is back-reflected by means of a specular or, preferably, diffuse reflector 13, the latter preferably not being in optical contact with the light guide 1. This enables additional smoothing of the light intensity across the light guide 1.

Since, according to the embodiment shown in FIG. 1, the surface area covered on the side 11 of the light guide 1 by the light output unit 3 is smaller than the surface area covered on the side 10 of the light guide 1 by the light input unit 2, the light generating device shown in FIG. 1 acts as a light concentrator.

Another embodiment of a light generating device according to the present invention which can be preferably used as a homogeneously light-emitting back-light for a large-area liquid crystal display (LCD) screen is shown in FIG. 2. Therein the light input unit 2 is spread across the whole side 10 of the light guide 1, while the light output unit 3 is also spread across the whole side 11 of the light guide 1. Within the light input unit 2 individual light sources 20 are regularly positioned along the side 10. As such, their number can be made to scale with the surface area of the side of the light guide 1, which will normally be the same as that of the display screen surface area. The light is then made to exit the light output unit 3 covering the entire opposite side 11 of the light guide 1. This exiting light 6 is laterally homogeneously emitted from the output unit 3 and collimated to a degree dependent on the design parameters of the outcoupling optical elements 32 of the light output unit 3. Choosing appropriate values for the spacing, size, and shape design parameters of the incoupling optical elements 22 and outcoupling optical elements 32 in the light input and light output units 2, 3, respectively, use of an additional light curtain screen and/or light diffuser screen for enabling a laterally homogeneous light emission to be obtained from the light output unit 3 (i.e. a laterally homogeneous brightness level) can be avoided.

The light generating device according to the present invention can also be used as a light concentrator. This becomes possible when the area covered by the light output unit 3 is much smaller than that of the light input unit 2 as shown in FIG. 1. This may find application in the area of general lighting, i.e. for the creation of one or more local spots on the light guide 1 emitting a high intensity of collimated light. Another application is the transport and concentration of incident sunlight that is captured across a large surface area of the light guide 1. Therefore, the light input unit may further comprise a light directing means for the directing of sunlight towards the light incoupling optical elements 22. In such an application the light output unit can be located not only somewhere on the side 11 of the light guide 1 but also on an edge 12 of the light guide 1.

The light generating device according to the present invention can also be used as a light diluter and/or homogeniser as shown in FIG. 3. This can find application in the area of general lighting when e.g. the intense light emitted by a few HID lamps is to be homogenised and spread across a large emitting surface area. This is possible when the light 4 emitted by these lamps is locally fed into an input unit 2 on the light guide 1. Inside the light guide 1 the light 5 is subsequently homogenised through TIR and multiple diffuse reflections from reflectors 13 at the edges 12 of the light guide 1. Subsequently, collimated light 6 is emitted through one or more output units 3 having an area larger than that of the input unit(s) 2.

Another advantageous embodiment of the light generating device according to the present invention which may be used for decorative lighting purposes is illustrated in FIG. 4. Therein, various (fixed) light input units 2 having associated light sources 20 can be present on one side 10 of the light guide 1 while the optical contact areas of the light output units 3 with the surface 11 of the light guide 1 are shaped, sized and located according to consumer demands. This is achieved by mounting the outcoupling optical elements 32 of a given output unit 3 on top of a transparent glass or plastic plate 36 that is provided with a soft transparent silicone rubber layer 37 underneath. When pressed against the surface 11 of the light guide 1, the rubber layer 37 will adhere to the smooth surface 11 and establish optical contact. Analogously, a local output unit 3 can be peeled from the light guide 1 and repositioned elsewhere on the light guide surface 11 or entirely removed.

The shape and area of the optical contact interface of an outcoupling optical element 32 on a side 11 of the light guide 1 can be arbitrarily chosen, as well as the number of light output units 3 and their position. As such, the consumer possesses a buffered storage reservoir of light in a ceiling or wall—mounted light guide 1 from which he can draw light at any desired location with adjustable spot sizes and spot shapes. Thus, spot illumination from multiple spots can be created. It should be noted that the light input unit 2 can contain, e.g. only one or a few TL tubes.

It should be noted that between incoupling optical elements 22 of a light input unit 2 a reflective layer may also be provided which is in optical contact with the light guide 1, said reflective layer being specularly reflective on the side facing the light guide.

FIG. 5 shows a further embodiment of a light generating device according to the present invention. Therein the light input unit is adapted for directing incident sunlight 40 into the light guide 1 via the light incoupling means 21. Further, a reflecting mirror 7 for redirecting sunlight rays 41 into the light guide 1 is provided for improving the efficiency of use of sunlight. Of course, additional light sources can also be provided in the light input unit.

The present invention provides a light generating device in which the light guide acts as a light buffer. The layout of the device is simple, which can be used in a wide range of different applications.

1. Light generating device comprising
a slab light guide having two substantially parallel sides and at least one edge the edge having a surface connecting the surfaces of said sides,
at least one light input unit arranged on at least one side of said light guide comprising at least one light source and a light incoupling means for coupling light into said light guide, and
at least one light output unit arranged on at least one side of said light guide comprising a light outcoupling means for coupling light out of said light guide.

2. Light generating device as claimed in claim 1, wherein said light incoupling means comprises a plurality of incoupling optical elements being in optical contact with the surface of said at least one side of said light guide, said incoupling optical elements having a reflective surface section facing the light source and being aligned substantially parallel to the surface of a side of said light guide and at least one transparent surface section being arranged at an angle different from 0°, in particular at an angle of substantially 90°, with respect to the surface of a side of said light guide.

3. Light generating device as claimed in claim 2, wherein said incoupling optical elements are arranged at intervals and wherein between said incoupling optical elements light reflecting means are arranged, in particular a structured reflective foil or structured reflective mask that is substantially not in optical contact with said light guide.

4. Light generating device as claimed in claim 2, wherein said incoupling optical elements are arranged at intervals and wherein between said incoupling optical elements light reflecting means are arranged, in particular a reflective layer in optical contact with said light guide, that is specularly reflective on the side facing the said light guide.

5. Light generating device as claimed in claim 2, wherein a reflective surface section (of the said incoupling optical elements is diffusely reflective having a reflectivity of substantially 100% at the side of said reflective surface section facing away from the light guide.

6. Light generating device as claimed in claim 1, wherein said light outcoupling means comprises a plurality of outcoupling optical elements being in optical contact with the surface of said at least one side of said light guide, said outcoupling optical elements having at least one transparent surface section (being arranged at an angle different from 0°, in particular at an angle of substantially 90° with respect to the surface of a side of said light guide.

7. Light generating device as claimed in claim 6, wherein said outcoupling optical elements are arranged at intervals and wherein between said outcoupling optical elements light reflecting means are arranged, in particular a shaped foil, having a reflective surface facing away from said light guide, in particular a specularly reflecting surface that is inclined with respect to the transparent surface section of said outcoupling optical elements, the separation between said transparent surface section of said outcoupling optical elements and said specular reflecting surface of said shaped foil widening in the direction away from the said light guide.

8. Light generating device as claimed in claim 1, wherein said light guide is provided with light reflection means, in particular a specular or diffuse reflector, at its edge, the diffuse reflector being substantially not in optical contact with said light guide.

9. Light generating device as claimed in claim 1, comprising only one light input unit and/or one light output unit, wherein the light input unit and/or the light output unit extend(s) substantially across one whole surface area of one side of said light guide.

10. Light generating device as claimed in claim 1, wherein the surface area of the at least one side that is covered by the at least one light input unit is larger than the surface area of the at least one side that is covered by the at least one light output unit.

11. Light generating device as claimed in claim 1, wherein the surface area of the at least one side that is covered by the at least one light input unit is smaller than the surface area of the at least one side that is covered by the at least one light output unit.

12. Light generating device as claimed in claim 1, wherein said at least one light input unit further comprises a light-directing means for directing light, in particular sunlight and/or light generated from external light sources, into said at least one light input unit.

13. Light generating device as claimed in claim 1, wherein said at least one light output unit is provided with a transparent fixing means for non-permanently fixing the light output unit at an arbitrary position onto a side of said light guide.

14. Display device comprising a display screen, in particular a LC display screen, and a light generating device as claimed in claim 1.

15. Display device as claimed in claim 14, wherein said light generating device comprises only one light input unit and one light output unit, wherein the light input unit extends substantially over the whole surface area of the side of said light guide facing away from said LC display screen and wherein the light output unit extends substantially over the whole surface area of the side of said light guide facing the LC display screen, and wherein the size and geometry of the side of said light guide facing the LC display screen substantially corresponds to the size and geometry of the LC display screen.
